(19) United States
(12) Patent Application Publication
(10) Pub. No.: US 2017/0292556 A1
(43) Pub. Date: Oct. 12, 2017

(54) Chimeric Fasteners

(71) Applicants: James Paul Hoeffler, Prankston, TX (US); Michel G. Denis, Calgary (CA)

(72) Inventors: James Paul Hoeffler, Prankston, TX (US); Michel G. Denis, Calgary (CA)

(21) Appl. No.: 15/094,071

(22) Filed: Apr. 8, 2016

(51) Int. Cl. F16B 35/04; F16B 19/06

(52) U.S. Cl. CPC F16B 35/041; F16B 19/06

(57) ABSTRACT

The present invention provides a fastener that serves as a replacement for joining a pair of metal sheets or similar materials. The fastener can be used to replace an original fastener that has worm a large hole into the sheets of material. The fastener provides a widened shaft to accommodate the widened hole while retaining a small head size comparable to that of the original fastener. In this way, the fastener of the present invention can be used in the widened hole while retaining the appearance of the original fastener.

### BACKGROUND

Screws and other similar fasteners are used to joint two surfaces to one another. The hole formed by the screw in the materials can gradually enlarge or widen over time, causing the fastener to become loose. As a result, mechanics and other workers often replace the original fastener with a larger fastener with a larger fastener, or use glue or other adhesive to reinforce the fastener. These solutions, however, may cause an unsightly appearance that detracts from the appearance of the joined surfaces. Thus, a device for replacing an original fastener with a larger gripped fastener while retaining the original appearance is desired.

### DESCRIPTION OF INVENTION

Referring now to FIG. 1, there is shown an embodiment of the fastener of the present invention. The present invention provides a fastener having a widened shaft while retaining a conventional head size. Fasteners, such as screws, used to join of a pair of sheet metal surfaces can become loose over time, requiring the screw to be replaced with a larger screw. However, such larger screws include larger head sizes, which differ in appearance from the head size of the original fastener.

Referring now to FIGS. 2 and 3, there are shown views of patterns of fasteners and replacement fasteners. The fastener of the present invention provides a widened shaft for securing and reinforcing the widened hole in the sheet material, while retaining a convention head size so that the fastener resembles the original fastener. In this way, the pattern of fasteners remains uniform and it will be not readily apparent that a replacement fastener has been used.

Referring now to FIGS. 4A, 4B, 4C, and 5, there are shown views of conventional fasteners and fasteners of the present invention. The fastener of the present invention can be any type of conventional fastener, such as a hex bolt or machine screw, among other types of fasteners. The fastener of the present invention differs by providing a widened shaft while retaining the original head size. In this way, fasteners of the present invention can serve as replacement fasteners for securing two sheets of material to one another, while retaining the appearance of the original fastener.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

### BRIEF DESCRIPTION OF FIGURES

FIG. 1 shows a view of an embodiment of the fastener of the present invention.

FIG. 2 shows a view of a replacement fastener that provides an undesirable appearance.

FIG. 3 shows views of fastener head patterns with different replacement fasteners.

FIG. 4A shows a view of a first type of hex bolt.

FIG. 4B shows a view of a second type of hex bolt.

FIG. 4C shows a view of a hex bolt of the present invention.

FIG. 5 shows various types of conventional fasteners as compared to fasteners of the present invention.

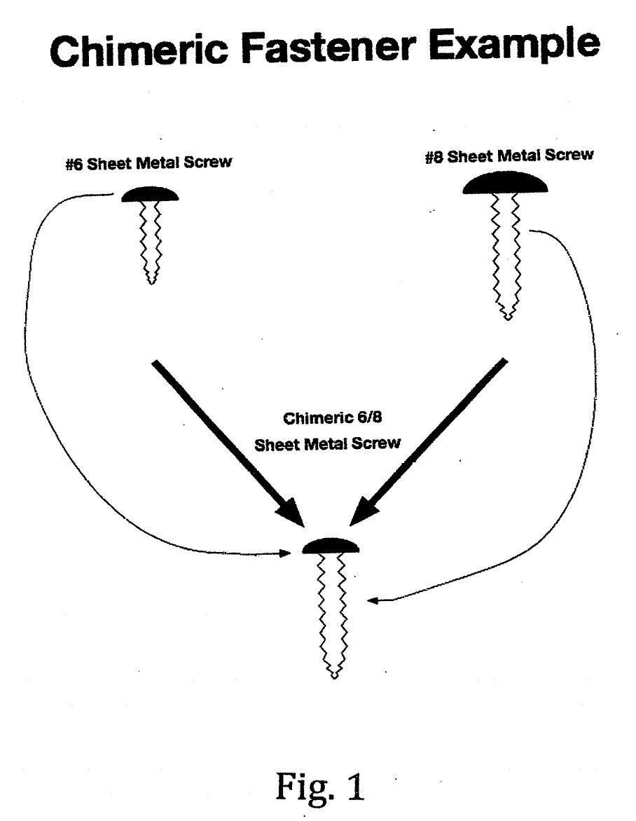

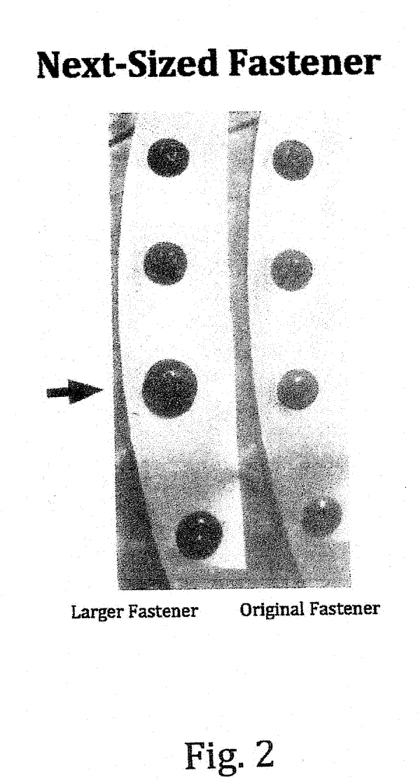

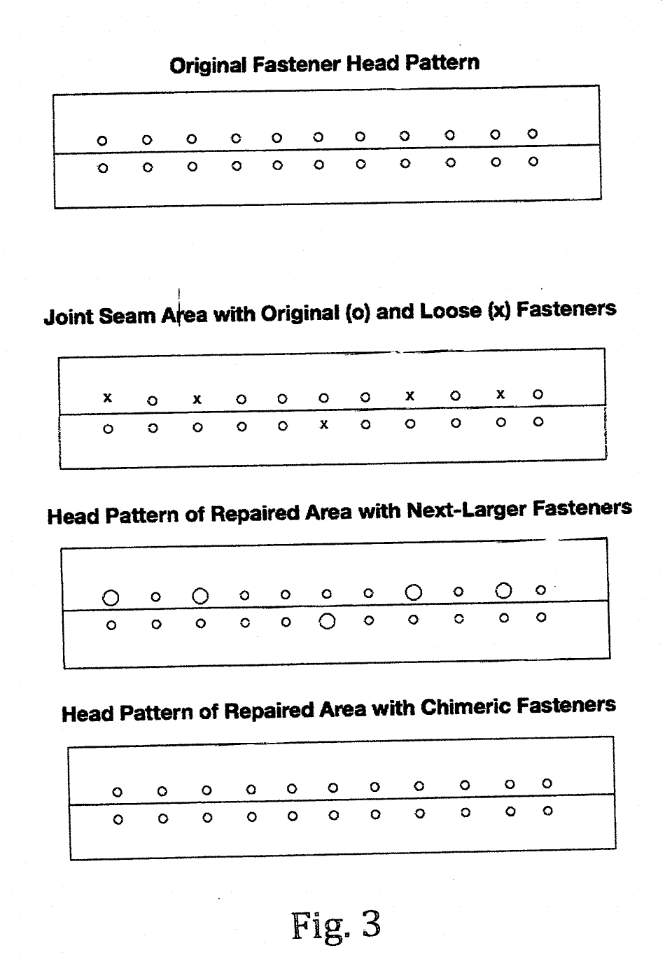

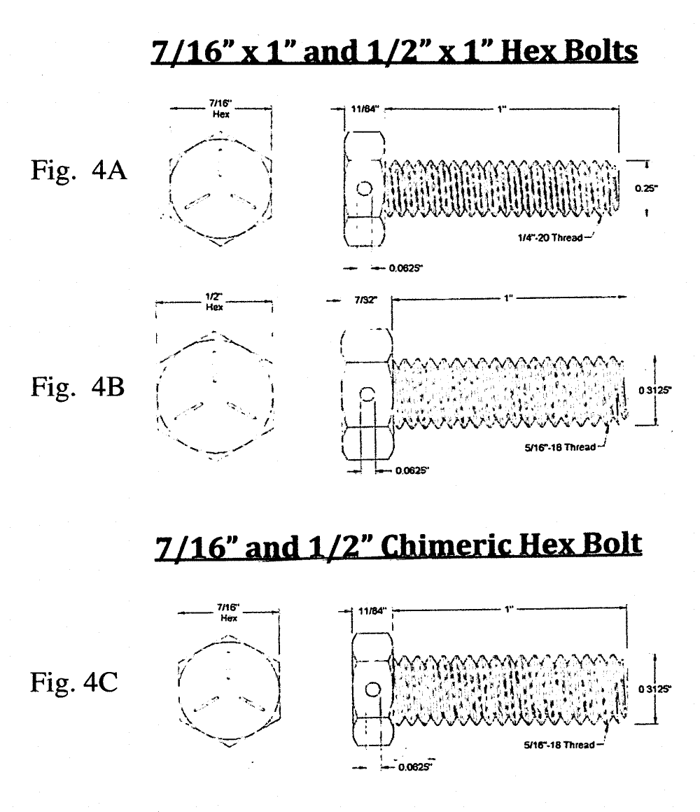

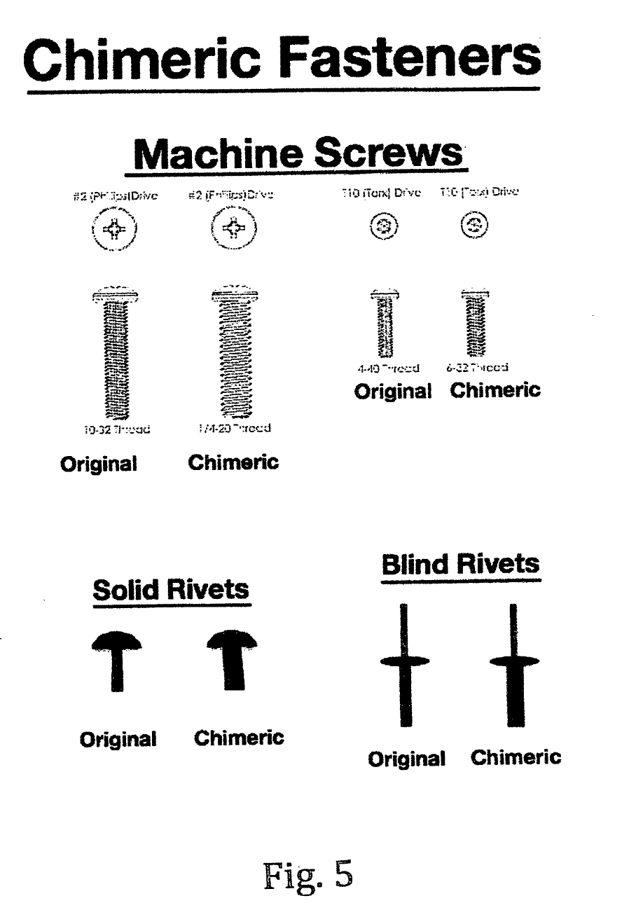

We claim:

1. A chimeric fastener having a widened shaft while retaining a conventional head size.

2. The chimeric fastener of claim 1 wherein said fastener provides a widened shaft for securing and reinforcing a widened hole in the fastened material, while retaining a conventional head size so that the chimeric fastener resembles the original fastener.
